(19) United States
(12) Patent Application Publication
(10) Pub. No.: US 2008/0037456 A1
(43) Pub. Date: Feb. 14, 2008

(54) System of establishing VoIP connection by mobile phone

(75) Inventor: Ming-Hua Chen, Sindian City (TW)

Correspondence Address: BIRCH STEWART KOLASCH & BIRCH, PO BOX 747, FALLS CHURCH, VA, 22040-0747, US

(73) Assignee: MOBILE ACTION TECHNOLOGY INC.

(21) Appl. No.: 11/480,359

(22) Filed: Jul. 5, 2006

(51) Int. Cl. H04Q 7/00

(52) U.S. Cl. 370/313

(57) ABSTRACT

A system of establishing a VoIP connection has a network device linking to Internet and building at least one VoIP connection software, a mobile phone having a blue tooth device and an antenna adapted to link to a base station, and a blue tooth headset linked to the blue tooth device of the mobile phone and the blue tooth device of the network device. The blue tooth headset builds a dialing procedure used to establish a VoIP connection through the network device to make a VoIP phone call. Therefore, a mobile phone user can use the mobile phone to make a mobile phone call, a local phone call and a VoIP phone call and does not set in front of the computer to make a VoIP phone call.

### BACKGROUND OF THE INVENTION

1. Field of the Invention

The present invention relates to a system of establishing VoIP connection, and more particularly to a system of establishing VoIP connection by mobile phone.

2. Description of Related Art

With reference to FIG. 4, an earliest VoIP system construction mainly includes at least two computers (10, 10a) link to each other via a VoIP server (20) on Internet. The VoIP server (20) stores each computer's identity data, so the VoIP server (20) establishes a voice connection on Internet between the two computers (20) when one of the two computer (10, 10a) sends a dialing massage to the VoIP server (20). After a voice connection is established, users of the two computers can use the software (such as Skype™, MSN™, Yahoo Messageer™ etc.) and the hardware (such as microphone) of the computers (10, 10a) to communicate with each other via the voice connection on Internet.

People know that the VoIP can save lots of money for phone calls, but there are many disadvantages of the forgoing VoIP system construction. The VoIP system construction has to require computers to establish a voice connection on Internet, so it is not convenient for most of people to dial the VoIP telephone number. In addition, the VoIP system construction does not establish a voice connection between the computer on Internet and a telephone on PSTN. That is, the user does not dial a local telephone number by the VoIP system construction.

With reference to FIG. 5, another VoIP system construction mainly includes a computer (10), a VoIP server (20), a VoIP gateway (21), a digital PBX (30) and a telephone (31). The PBX (30) is respectively connected to the VoIP server (20) on Internet through the VoIP gateway (21) and the local telephone lines of PSTN. The telephone (31) connected to the PBX (30) receives the voice signals from PSTN or Internet. Therefore, the computer (10) user uses the software and hardware of the computer (10) to make a VoIP phone call to the telephone user. Although this VoIP system construction allows one end of the voice connection uses a local telephone on PSTN, the other end thereof still has to use the computer.

Therefore, the present invention provides a new VoIP system based on the forgoing VoIP system construction to allow the user uses own mobile phone to make a VoIP phone call.

### SUMMARY OF THE INVENTION

The main objective of the present invention is to provide a system and a method of establishing a VoIP voice connection by using a mobile phone. The mobile phone user can uses the mobile phone to make a VoIP phone call to save lots of money.

A system of establishing a VoIP connection has a network device linking to Internet and building at least one VoIP connection software, a mobile phone having a blue tooth device and an antenna adapted to link to a base station, and a blue tooth headset linked to the blue tooth device of the mobile phone and the blue tooth device of the network device. The blue tooth headset builds a dialing procedure used to establish a VoIP connection through the network device to make a VoIP phone call. Therefore, a mobile phone user can use the mobile phone to make a mobile phone call, a local phone call and a VoIP phone call and does not set in front of the computer to make a VoIP phone call.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a construction of a system in accordance with the present invention;

FIG. 2 is a time sequence drawing of establishing a VoIP connection by the system in accordance with the present invention;

FIG. 3 is a flow chart of dialing VoIP phone call based on the system in accordance with the present invention;

FIG. 4 is a block diagram of a conventional VoIP system construction in accordance with the prior art; and

FIG. 5 is another block diagram of a conventional VoIP system construction in accordance with the prior art.

### DETAILED DESCRIPTION OF THE PREFERRED EMBODIMENT

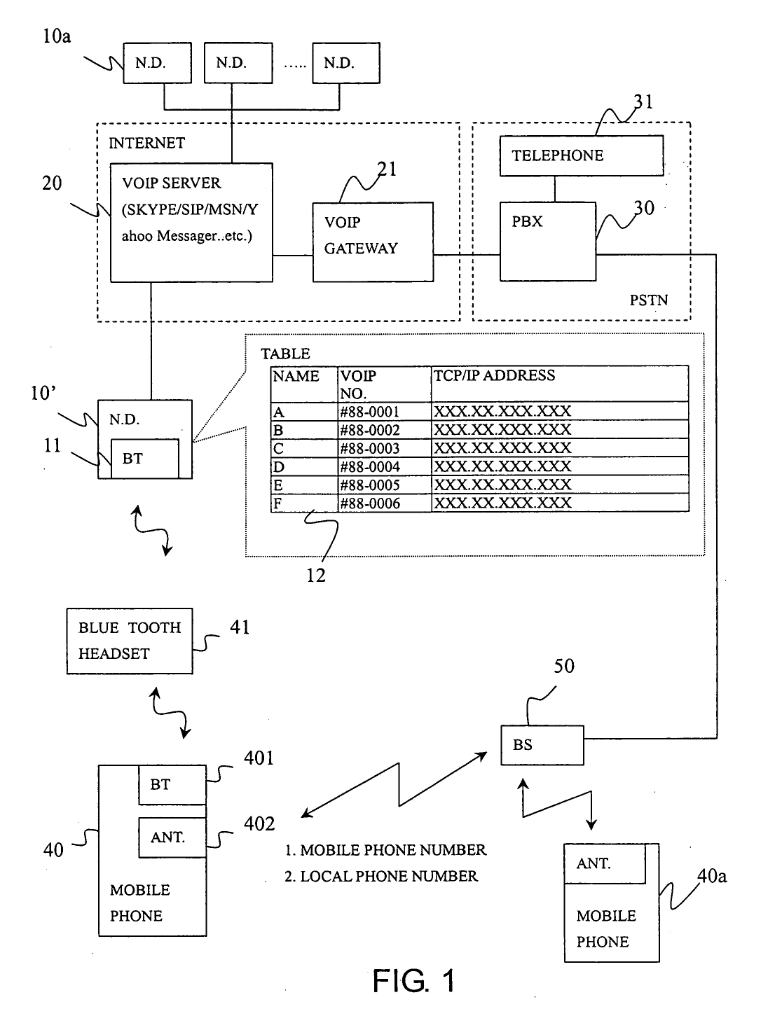

With reference to FIG. 1, a preferred embodiment of a system in accordance with the present invention includes a network device (10′) (such as a computer, PDA, etc.), at least one mobile phone (40) having a wireless transceiver device (401), and at least one wireless headset (41). The wireless transceiver device (401) can be a blue tooth module, a WIFI module, IR transceiver or the like. The wireless headset could be a blue tooth headset, WIFI headset, IR headset or the like. In this embodiment, the wireless transceiver uses a blue tooth device (401) and the wireless headset uses a blue tooth headset (41).

The network device (10′) is used to link to Internet and builds at least one VoIP connection software (such as Skype™, SIP, MSN™, Yahoo Messageer™ etc.) having a member table (12) composed of multiple member's name, member's VoIP phone numbers and TCP/IP addresses corresponding to the VoIP phone numbers, and a wireless transceiver, such as a blue tooth device (11) connected to other blue tooth device.

The mobile phone (40) has an antenna (402) used to connect to a base station (50) and. The mobile phone (40) can link to the other mobile phones (40a) or PSTN telephones (31) through the base station (50). That is, in general the mobile phone user uses the mobile phone (40) to dial the mobile phone number and local phone number and communicate with the remote end such as mobile phone (40a), telephone (31) etc. In the system in accordance with the present invention, the mobile phone (40) requires a blue tooth device (401) to link to other blue tooth devices in a variable communicate rage.

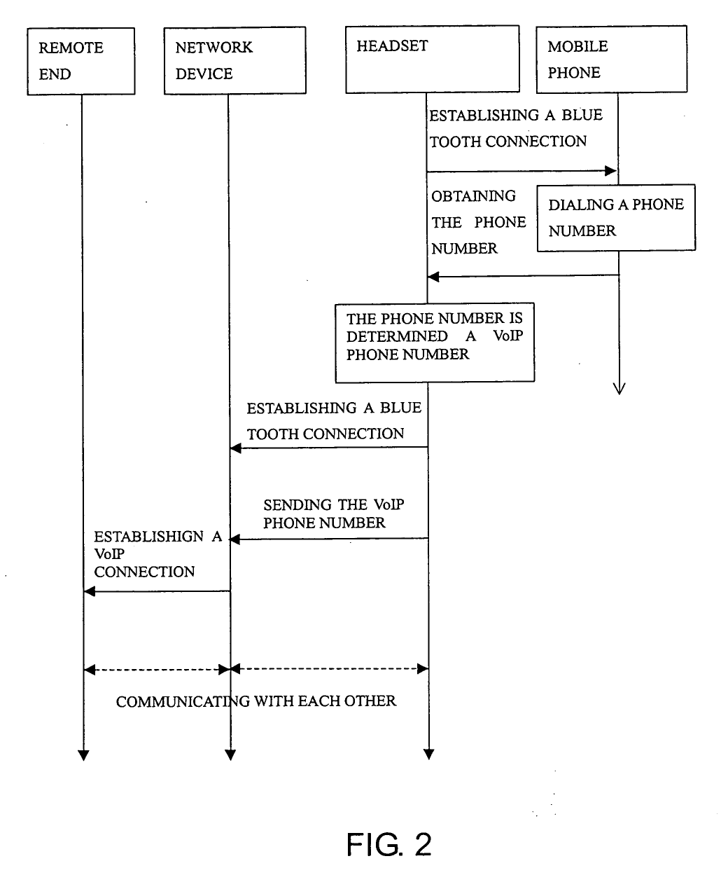

The blue tooth headset (41) is prepared to the mobile phone user. The user does not touch the mobile phone (40) to answer the phone when mobile phone (40) is communicating with the other mobile phone (40a) or telephone (31). In the system in accordance with the present invention, the blue tooth headset (41) further additionally builds a dialing procedure in a memory unit of the blue tooth headset (41). With further reference to FIG. 2, since the blue tooth headset (41) links to the blue tooth device (401) of mobile phone (40) based on the blue tooth protocol, the blue tooth headset (41) with the dialing procedure determines whether the dialing number of the mobile phone (40) is a VoIP phone number or is not local phone number or mobile phone number. When the blue tooth headset determines the dialing phone number is a VoIP phone number, the blue tooth headset starts to link to the network device (10′) and then sends the dialing phone number to the network device (10′). After then, the network device (10′) executes the VoIP connection software to establish a VoIP connection with the remote end on Internet through the VoIP server (20). When the VoIP connection is established, the blue tooth headset (41) transmits the user's voice signals to the remote end of the VoIP connection.

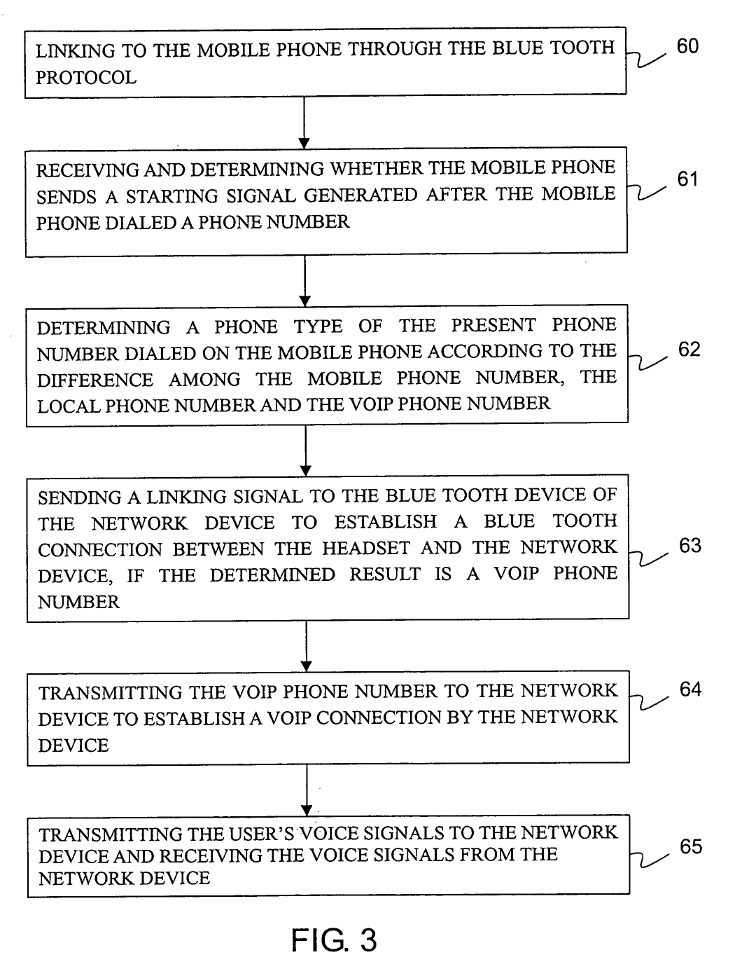

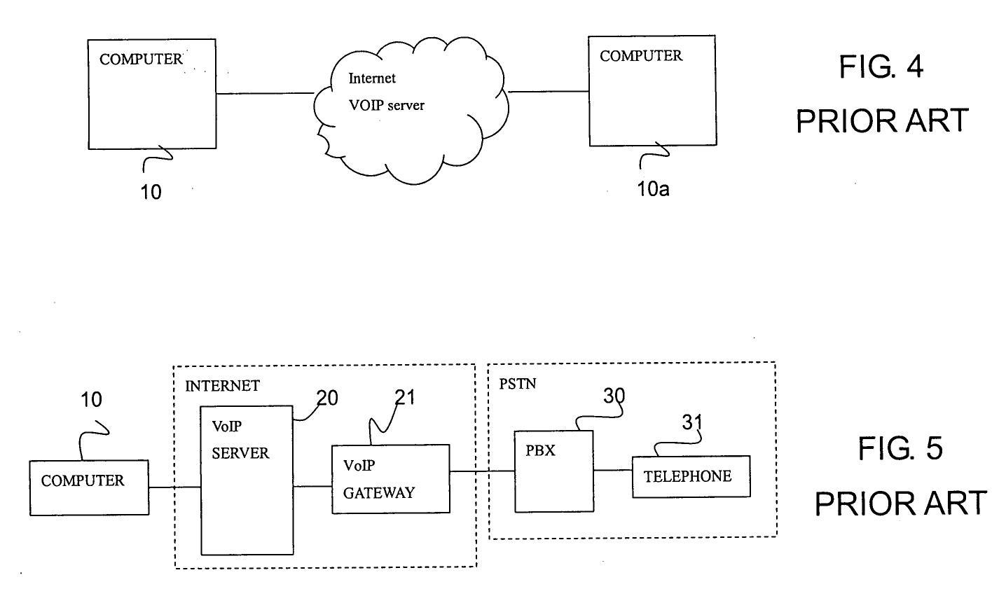

With reference to FIG. 3, a detail flow chart of the dialing procedure is shown. The dialing procedure includes steps of:

linking to the mobile phone through the blue tooth protocol (60);

receiving and determining whether the mobile phone sends a dialing signal generated after the mobile phone dialed a phone number (61);

determining a phone type of the present phone number dialed by the mobile phone according to the different feature among the mobile phone number, the local phone number and the VoIP phone number (62);

sending a linking signal to the blue tooth device of the network device to establish a blue tooth connection between the headset and the network device, if the determined result is a VoIP phone number (63);

transmitting the VoIP phone number to the network device to establish a VoIP connection by the network device (64); and

transmitting the user's voice signals to the network device and receiving the voice signals from the network device (65).

In general, a code length of the mobile phone number is longer than that of the local phone number or that of the VoIP phone number. The front-lead code of the codes of the VoIP phone number differs from that of the local phone number. Therefore, in the determining a phone type step of the dialing procedure, the VoIP phone number can be determined by code length and front-lead code of the phone number dialed by the mobile phone. If the phone number dialed by the mobile phone is not a VoIP number, the headset does not send a linking signal to the network device and at the time mobile phone links to the base station to execute a normal communication procedure.

Again, since the network device is always links to Internet and builds the VoIP connection software, the network device executes the VoIP connection software and compare the VoIP phone number sent by the headset with each VoIP number of the member table. When one VoIP number of the member table and the VoIP phone number sent by the headset matches, the network device will read a TCP/IP address corresponding to the VoIP number. The network device links to one VoIP server corresponding to the TCP/IP address of Internet to execute a normal establishing VoIP connection procedure.

Based on the forgoing description, the mobile phone user can uses the mobile phone to remote the network device to make a VoIP phone call through it's wireless headset. Therefore, the user uses own mobile phone to dial the mobile phone number, local phone number and the VoIP phone number, and the user does not always sets in front of the network device, such as computer to make a VoIP phone call.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A system of establishing VoIP connection by mobile phone, comprises:
a network device linking to Internet and building at least one VoIP connection software having:
a member table composed of multiple member's VoIP phone numbers and TCP/IP addresses corresponding to the member's VoIP phone numbers; and
a first wireless transceiver;
a mobile phone having a second wireless transceiver and an antenna adapted to link to a base station;
a wireless headset linked to the second wireless transceiver of the mobile phone and the first wireless transceiver of the network device, wherein the wireless headset builds a dialing procedure used to establish a VoIP connection through the network device to make a VoIP phone call.

2. The system as claimed in claim 1, wherein the dialing procedure built in the blue tooth headset comprises steps of:
linking to the mobile phone through a wireless communication protocol followed by the second wireless transceiver and the wireless headset;
receiving and determining whether the mobile phone sends a dialing signal generated after the mobile phone dialed a phone number;
determining a phone type of the present phone number dialed by the mobile phone according to a different feature among a mobile phone number, a local phone number and a VoIP phone number;
sending a linking signal to the first wireless transceiver of the network device to establish a wireless communicating connection between the wireless headset and the network device, if the phone type of the present phone number is a VoIP phone number;
transmitting the present phone number to the network device through the wireless communicating connection to establish a VoIP connection by the network device; and
transmitting the user's voice signals to the network device and receiving the voice signals from the network device.

3. The system as claimed in claim 2, wherein the different feature is that code lengths of the mobile phone number, local phone number and VoIP phone are different.

4. The system as claimed in claim 2, wherein the different feature is that front-lead codes of the local phone number and VoIP phone are different.

5. The system as claimed in claim 1, wherein the first wireless transceiver is a blue tooth module, a WIFI module or an IR module.

6. The system as claimed in claim 1, wherein the wireless headset is a blue tooth headset, a WIFI headset or an IR headset.

7. The system as claimed in claim 1, wherein the second wireless transceiver is a blue tooth module, a WIFI module or an IR module.

8. A wireless headset of a mobile phone comprising a third wireless transceiver built a dialing procedure, wherein the dialing procedure comprises steps of:
linking to the mobile phone through a wireless communication protocol followed by the second wireless transceiver;
receiving and determining whether the mobile phone sends a dialing signal generated after the mobile phone dialed a phone number;
determining a phone type of the present phone number dialed by the mobile phone according to a different feature among a mobile phone number, a local phone number and a VoIP phone number;
sending a linking signal to a first transceiver of the network device linking to Internet to establish a wireless communicating connection between the wireless headset and the network device, if the phone type of the present phone number is a VoIP phone number;
transmitting the present phone number to the network device through the wireless communicating connection to establish a VoIP connection by the network device; and
transmitting the user's voice signals to the network device and receiving the voice signals from the network device.

9. The wireless headset as claimed in claim 8, wherein the different feature is that code lengths of the mobile phone number, local phone number and VoIP phone are different.

10. The wireless headset as claimed in claim 8, wherein the different feature is that a front-lead codes of the local phone number and VoIP phone are different.

11. The wireless headset as claimed in claim 8, wherein the first wireless transceiver is a blue tooth module, a WIFI module or an IR module.

12. The wireless headset as claimed in claim 8, wherein the wireless headset is a blue tooth headset, a WIFI headset or an IR headset.

13. The wireless headset as claimed in claim 8, wherein the second wireless transceiver is a blue tooth module, a WIFI module or an IR module.
